(19) United States
(12) Patent Application Publication
(10) Pub. No.: US 2024/0244499 A1
(43) Pub. Date: Jul. 18, 2024

(54) METHODS AND APPARATUS FOR PROVIDING MOBILITY STATE INFORMATION

(71) Applicant: Telefonaktiebolaget LM Ericsson (publ), Stockholm (SE)

(72) Inventors: Pradeepa RAMACHANDRA, Linköping (SE); Nicklas JOHANSSON, Linköping (SE); Roman ZHOHOV, Sundbyberg (SE); Ali PARICHEHREHTEROUJENI, Linköping (SE)

(21) Appl. No.: 18/548,982

(22) PCT Filed: Mar. 5, 2021
(86) PCT No.: PCT/EP2021/055691

§ 371 Date: Sep. 5, 2023

(51) Int. Cl. H04W 36/32; H04B 7/06; H04W 36/36; H04W 56/00

(52) U.S. Cl. CPC H04W 36/324; H04B 7/0617; H04W 36/362; H04W 56/0045

(57) ABSTRACT

Methods and apparatus are provided for providing mobility state information in a radio access network. In certain embodiments a method is performed by a first network node of a radio access network. The method includes obtaining one or more mobility state related parameters and determining mobility state information of a wireless device in a connected mode with the radio access network. The mobility state information is determined based on the one or more mobility state related parameters. The first network node communicates the determined mobility state information to a second network node.

### CROSS-REFERENCE TO RELATED APPLICATIONS

This application is a 35 U.S.C § 371 national stage application for International Application No. PCT/EP2021/055691, entitled “METHODS AND APPARATUS FOR PROVIDING MOBILITY STATE INFORMATION”, filed on Mar. 5, 2021, assigned to the assignee hereof, and expressly incorporated herein by reference.

### TECHNICAL FIELD

Embodiments herein relate generally to providing mobility state information of one or more wireless devices and in particular methods and apparatus for indicating mobility state information for a wireless device in a connected mode with a radio access network.

### BACKGROUND

An RRC_CONNECTED UE in LTE (also called EUTRA) can be configured by the network to perform measurements and, upon triggering measurement reports the network may send a handover command to the UE (where the handover command is conveyed by a mobilityControlInfo IE in an RRCConnectionReconfiguration message in LTE and by a reconfigurationWithSync IE in an RRCReconfiguration message in NR).

These reconfiguration fields, i.e. mobilityControlInfo and reconfigurationWithSync, are actually prepared by the target node, which is responsible for the target cell, upon a request from the source node (over X2 or S1 interface in case of EUTRA-EPC or Xn or NG interface in case of EUTRA-5GC or NR-5GC) and takes into account the existing RRC configuration the UE has with source cell (which is provided in the inter-node request). Among other parameters, the reconfiguration provided by target node contains all information the UE needs to access the target cell, e.g., random access configuration, a new C-RNTI assigned by the target node to be valid in the target cell and security parameters enabling the UE to calculate new security keys associated with the target cell so the UE can send a handover complete message on SRB1 (encrypted and integrity protected) based on new security keys upon accessing the target cell.

FIG. 1 demonstrates a signaling flow between the UE, the source node and the target node during a handover procedure in the NR/5GC scenario.

Both in LTE and NR, some principles exist for handovers (or in more general terms, mobility in RRC_CONNECTED state):
Mobility in RRC_CONNECTED state is network-based as the network has the best information regarding the current situation, such as load conditions, resources in different nodes and cells, available frequencies, etc. The network can also consider the situation of many UEs in the network, for a resource allocation perspective, e.g. involving handovers for load balancing purposes.
The network prepares a target cell before the UE accesses that cell. The source node provides the UE with the RRC configuration to be used in the target cell (i.e. the RRC configuration received from the target node in case of inter-node handover), including SRB1 configuration to send the HO complete message.
The UE is provided by the target node with a target C-RNTI i.e. the target node identifies the UE from MSG.3 on the MAC level. More precisely, the C-RNTI is included in a C-RNTI MAC CE in the MAC PDU containing the HO complete message. Hence, there is no context fetching, unless a failure occurs.
To speed up the handover, the network provides the needed information on how to access the target e.g. RACH configuration, so the UE does not have to acquire SI in the target cell prior to the handover and target cell access.
The UE may be provided with contention free random access (CFRA) resources including a dedicated random access preamble, i.e. in that case the target node identifies the UE from the random access preamble (MSG.1). In addition, the CFRA procedure can be optimized with dedicated resources. In conditional handover (which is described further below) that might be a bit tricky as there is uncertainty about the final target cell and also about the timing.
The security mechanisms are prepared before the UE accesses the target cell i.e. keys must be refreshed before sending the HO complete message (i.e. the RRCConnectionReconfigurationComplete message in LTE or the RRCReconfigurationComplete message in NR), based on new keys and encrypted and integrity protected so the UE can be verified in the target cell.

Both full and delta reconfiguration (where delta reconfiguration means that only the differences from the old configuration are signaled) are supported so that the HO command can be minimized.

The UE will send a measurement report when the conditions as configured by the network are fulfilled. These conditions can be time based (e.g., periodic reporting) or the received signal related measurement based (e.g., event triggered reporting). The event triggered reporting is associated with RSRP (reference signal received power), RSRQ (reference signal received quality) or SINR (signal to interference and noise ratio) related measurements. The measurements used for evaluating the event triggering criterion are Layer 3 (L3) filtered.

In order to control when the measurement needs to be sent from the UE, the network can use several parameters like Ax-offset (A1 offset, A2 offset, . . . , A6 offset), frequency-specific offset, Time-To-Trigger (TTT), etc. An example of definition of A1 event (defined in the 3rd Generation Partnership Project (3GPP) technical specification, TS 38.331 (V16.3.1) clause.5.5.4.2) is captured as below for Event A1 (Serving becomes better than threshold)

```
----------------------------- begin excerpt from 3GPP document --------------------------------
The UE shall:
  1> consider the entering condition for this event to be satisfied when condition A1-1, as specified
    below, is fulfilled;
  1> consider the leaving condition for this event to be satisfied when condition A1-2, as specified
    below, is fulfilled;
  1> for this measurement, consider the NR serving cell corresponding to the associated
    measObjectNR associated with this event.
Inequality A1-1 (Entering condition)
Ms − Hys > Thresh
Inequality A1-2 (Leaving condition)
Ms + Hys < Thresh
The variables in the formula are defined as follows:
  Ms is the measurement result of the serving cell, not taking into account any offsets.
  Hys is the hysteresis parameter for this event (i.e. hysteresis as defined within reportConfigNR for
    this event).
  Thresh is the threshold parameter for this event (i.e. al-Threshold as defined within
    reportConfigNR for this event).
  Ms is expressed in dBm in case of RSRP, or in dB in case of RSRQ and RS-SINR.
  Hys is expressed in dB.
  Thresh is expressed in the same unit as Ms.
----------------------------- end excerpt from 3GPP document --------------------------------
```

The time-to-trigger parameter is defined as below in the 38.331 specification. The IE TimeToTrigger specifies the value range used for time to trigger parameter, which concerns the time during which specific criteria for the event needs to be met in order to trigger a measurement report. Value ms0 corresponds to 0 ms and behaviour as specified in 7.1.2 applies, ms40 corresponds to 40 ms, and so on:

----------------------------- begin excerpt from 3GPP document --------------------------------
Time ToTrigger information element
-- ASNISTART
-- TAG-TIMETOTRIGGER-START

| | |
|---|---|
| TimeToTrigger [symbol] | ENUMERATED { |
| | ms0, ms40, ms64, ms80, ms100, ms128, ms160, ms256, |
| | ms320, ms480, ms512, ms640, ms1024, ms1280, ms2560, |
| | ms5120} |
| -- TAG-TIMETOTRIGGER-STOP | |
| -- ASNISTOP | |

----------------------------- end excerpt from 3GPP document -------------------------------- [symbol]
indicates data missing or illegible when filed

In NR architecture a next generation Radio Access Node (NG-RAN), may comprise separate logical and/or physical nodes to handle the different protocol functions. One example of the separation of functions is depicted in FIG. 2, where a gNB comprises a centralized unit (CU) and one or more distributed units (DU). A gNB Central Unit (gNB-CU) is a logical node hosting Radio Resource Control (RRC), Service Data Adaptation Protocol (SDAP) and Packet Data Convergence Protocol (PDCP) protocols of the gNB or RRC and PDCP protocols of the en-gNB that controls the operation of one or more gNB-DUs. The gNB-CU terminates the F1 interface connected with the gNB-DU. A gNB Distributed Unit (gNB-DU) is a logical node hosting Radio Link Control (RLC), Medium Access Control (MAC) and physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

A further extension of the NR architecture is the Integrated access and backhaul (IAB) which enables wireless relaying in NG-RAN. In such an architecture the CU function resides in the IAB doner node and therefore the abovementioned logical F1 interface is, by virtue of the relaying functionality, a physical interface between IAB nodes and the IAB-donor-CU. The relaying node, referred to as IAB-node, supports access and backhauling via NR. The terminating node of NR backhauling on network side is referred to as the IAB-donor, which represents a gNB with additional functionality to support IAB. An example of the IAB architecture is shown in FIG. 3.

### SUMMARY

Cell reselection and handovers may be performed based on mobility state received from a wireless device or based on estimation by the node in control of the handover procedures. An number of problems arise with this approach for example the mobility state may only be determined by a wireless device in IDLE mode and informed to the gNB during radio resource control set-up, establishment or re-establishment procedures. As far as the mobility state is currently defined, the level of estimation is limited to some basic requirements.

Solutions are provided which address at least some of the abovementioned problems. Certain embodiments are provided for the radio access network to configure mobility state specific configurations and related features/procedures such as the type of handover (DAPS, conditional or normal handover) wherein the mobility state estimations may be improved in relation to reliability, comprehensiveness and autonomy. In particular, embodiments are provided to support a distributed radio access environment.

In one aspect, a method performed by a first network node is provided. The first network node is comprised in a radio access network. the method the method comprising obtaining one or more mobility state related parameters. Determining mobility state information of a wireless device wherein the wireless device is in a connected mode with the radio access network and the determined mobility state information is based on the one or more mobility state related parameters. The method further comprises communicating the determined mobility state information to a second network node. In one example of this aspect the mobility state information comprises at least one of direction of movement; and speed information of the wireless device. In one example of this aspect the obtained one or more mobility state related parameters are obtained from at least one of an uplink signal received from the wireless device, information related to downlink reference signals transmitted to the wireless device; and mobility state information obtained through processing previously stored mobility data of the wireless device. In one example of this aspect the obtained one or more mobility state related parameters comprises one or more of: a doppler shift in the uplink signals sent by the wireless device; a timing advanced measured in the uplink signals sent by the wireless device; a number of beam switches and/or the order of switched beams; and an angle of arrival of uplink signals sent by the wireless device. In one example of this aspect obtaining the one or more mobility state related parameters comprises the first network node determining at least one mobility state related parameter. In one example of this aspect the obtained one or more mobility state related parameters are based on a rate of change of DL beamforming changes towards the wireless device. In one example of this aspect the one or more parameters are determined based on: for analogue beamforming, the rate of change of CSI-RS beams used for data transmission; and for digital/hybrid beamforming, the rate of change of beamforming vectors and the range of changes in the beamforming vectors. In one example of this aspect the mobility state information obtained by processing previously stored mobility data is obtained from a machine learning entity based on at least one of: a doppler shift in the UL signals sent by the wireless device; a timing advanced measured in the uplink signals sent by the wireless device; a number of beam switches and the order of switched beams; an angle of arrival of the uplink signals sent by the wireless device; the wireless device location information; actual speeds of the wireless device; wireless device sensor information; time stamps; and mobility state information reported by the wireless device. In one example of this aspect the communicated mobility state information comprises one or more of: a classification of the wireless device mobility state as a relative level of mobility; a classification of the direction of the wireless device into one of a predefined set of directions. In one example of this aspect the method comprises determining the mobility state information periodically. In one example of this aspect the method comprises communicating the determined mobility state information to the second network node periodically. In one example of this aspect the method comprises communicating the determined mobility state to the second network node upon satisfying a criterion. In one example of this aspect the criterion comprises a threshold. In one example of this aspect the method comprises determining a predicted value of the wireless device speed or a predicted direction of movement and communicating the mobility state information based on the predicted value. In one example of this aspect the communicated mobility state information comprises one or more of the obtained mobility state related parameters. In one example of this aspect the method further comprises receiving a request for the mobility state information from the second network node. In one example of this aspect the first network node is a distributed unit and the second network node is a centralized unit. In one example of this aspect the first network node is an integrated access and backhaul distributed unit and the second network node is an integrated access and backhaul centralized unit. In one example of this aspect mobility state information is communicated in a mobility state information message within an F1 application protocol.

In another aspect, a method performed by a second network node is provided. The second network node is comprised in a radio access network. The method comprising receiving a mobility state information from a first network node for at least one wireless device which is in a connected mode with the radio access network. The method includes performing one of a mobility management and a radio resource management operation with the at least one wireless device based on the received mobility state information. In one example of this aspect performing the mobility management operation comprises performing one of: a non-conditional handover with the at least one wireless device; a conditional handover with the at least one wireless device; and a dual active protocol stack, DAPS, handover. In one example of this aspect the mobility state information comprises at least one of a direction of movement classification and a speed classification and the type of handover is selected based on the at least one direction of movement and speed classification. In one example of this aspect the mobility state information comprises a direction of movement classification and the handover is performed to a target cell from a subset of available cells based on the direction of movement classification. In one example of this aspect the performing a radio resource management operation comprise the second network node configuring or re-configuring a wireless device based on the received mobility state information. In one example of this aspect the second network node: configures the wireless device with reporting configurations associated to a handover when the reported mobility state information is classified with a first level of mobility. In another example the second network node configures the wireless device with reporting configurations associated to conditional handover when the reported mobility state information is classified with a second level of mobility, wherein the second level of mobility is associated with a greater level of mobility compared to the first level of mobility. In another example of this aspect the second network node configures fewer measurement objects related to high frequencies compared to the number for lower frequencies; and may additionally or alternatively configure fewer measurement objects related to frequencies where only small cells are deployed compared to the number of measurement objects for normal or large cells. In one example of this aspect the second network node is a centralized unit and the first network node is a distributed unit. In one example of this aspect the second network node is an integrated access and backhaul centralized unit and the first network node is an integrated access and backhaul distributed unit.

In another aspect, a first network node is provided. In some examples the first network node comprises a memory, processing circuitry and transceiver circuitry. The network node is configured to: obtain one or more mobility state related parameters; determine a mobility state information of a wireless device in a connected mode with a radio access network in which the first network node is comprised, based on the one or more mobility state related parameters; and communicate the determined mobility state information to a second network node. In some examples when the first network node comprises processing circuitry and transceiver circuitry, the transceiver circuitry is configured to obtaining the one or more mobility state related parameters and communicate the determined mobility state information; the processing circuitry being configured to determine the mobility state information. In further examples of this aspect, the first network node is configured to perform any one of the methods previously described for the first network node. In another aspect, a second network node is provided. In some examples the second network node comprises a memory, processing circuitry and transceiver circuitry. The second network node is configured to receive a mobility state information from a first network node for a wireless device which is in a connected mode with a radio access network in which the first network node is comprised; and perform one of a mobility management and radio resource management operation with the wireless device based on the received mobility state. In some examples when the second network node comprises processing circuitry and transceiver circuitry, the transceiver circuitry is configured to receive the mobility state information and the processing circuitry is configured to perform the mobility management operation or the radio resource management operation. In further examples of this aspect the second network node is configured to perform any one of the previously described methods performed by the second network node.

In another aspect a computer program, program product or carrier is provided. The computer program, program product or carrier comprising computer executable instructions which, when executed on a computer processor, cause the computer to perform any one of the methods described for the first network node or for the second network node.

In another aspect a method performed by a system is provided. The system comprising a first network node and a second network node in a radio access network configured to communicate with a plurality of wireless devices. The method comprising: obtaining one or more mobility state related parameters; determining, at the first network node, a mobility state information of a wireless device in a connected mode with the radio access network, based on the one or more mobility state related parameters; communicating the determined mobility state information to the second network node; receiving the mobility state information at the second network node for the wireless device and performing one of a mobility management and a radio resource management operation with the at least one wireless device based on the received mobility state information. In further examples of this aspect the method comprising performing any one of the methods of previously described.

### BRIEF DESCRIPTION OF THE DRAWINGS

FIG. 1 is a signalling sequence illustrating a handover procedure;

FIG. 2 is a block diagram illustrating NG-RAN architecture;

FIG. 3 is a block diagram illustrating NG-RAN incorporating IAB architecture;

FIG. 4 is a block diagram illustrating one or more concepts in accordance with the present disclosure;

FIG. 5 is a signalling sequence according to embodiments of the present disclosure;

FIG. 6 is a block diagram illustrating an communications network according to one or more embodiments of the present disclosure;

FIG. 7 is a block diagram illustrating example physical units of processing circuitry of a computing device useful for implementing the methods described herein, according to one or more embodiments of the present disclosure;

FIG. 8 is schematically illustrates a communication network according to one or more embodiments of the present disclosure;

FIG. 9 is a is a generalized block diagram of a host computer communicating via a base station with a user equipment over a partially wireless connection;

FIGS. 10 to 13 are flowcharts illustrating methods implemented in a communication system including a host computer, a base station and a user equipment;

FIG. 14 is a flowchart according to one or more embodiments of the present disclosure;

FIG. 15 is a flowchart according to one or more embodiments of the present disclosure;

FIG. 16 is a block diagram illustrating example software modules of a network node application useful for implementing the methods described herein, according to one or more embodiments of the present disclosure;

FIG. 17 is a block diagram illustrating example software modules of a network node application useful for implementing the methods described herein, according to one or more embodiments of the present disclosure;

FIG. 18 is a block diagram illustrating an example network node according to one or more embodiments of the present disclosure; and

FIG. 19 is a block diagram illustrating an example network node according to one or more embodiments of the present disclosure.

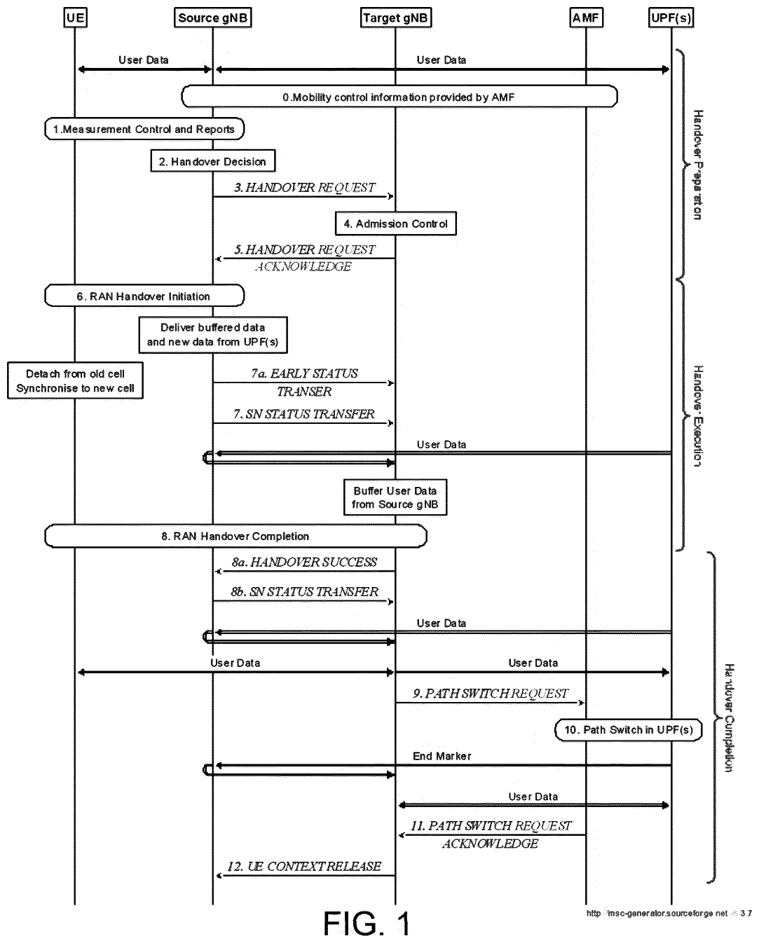

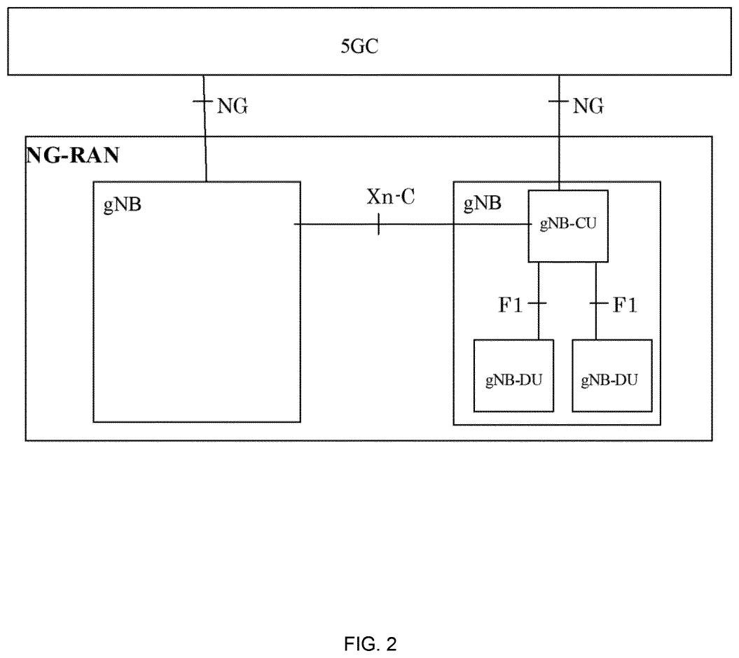

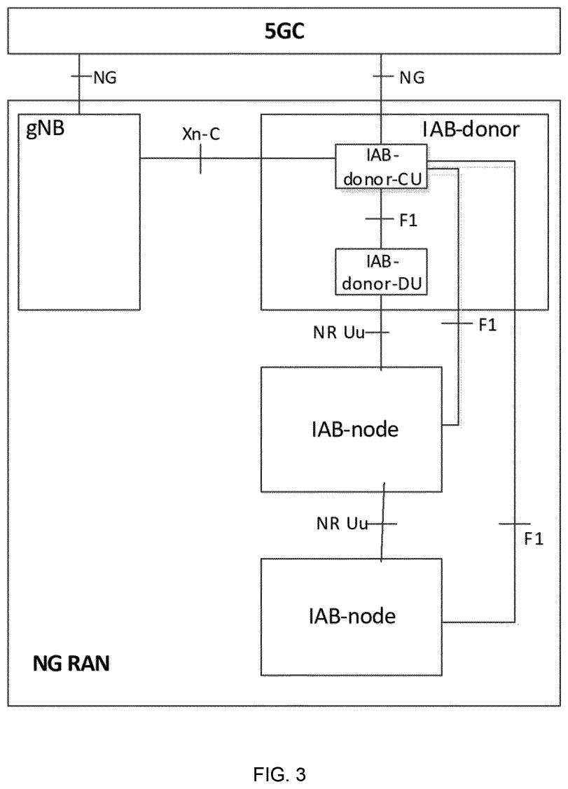

### DETAILED DESCRIPTION

The centralized unit of a RAN node, for example the logical function gNB-CU in an NG-RAN (although this separation may be equally applicable to an LTE or EN-DC RAN) controls, among other things, the handover of served wireless devices and/or IAB nodes in an IAB deployment. The handover decisions and types of handover selected may be based on measurement reports from the served wireless device or information from the other radio access network nodes, for example a gNB-DU or IAB node.

In the following disclosure when referring to CU or DU nodes, the reader shall understand that either the logical or physical separation of the functions of a RAN (e.g. gNB-DU/CU) or IAB physical nodes (IAB-DU/CU) is inferred, unless explicitly described otherwise.

IAB nodes provide backhauling via a single or via multiple hops.

The IAB-node supports distributed unit (DU), e.g. gNB-DU, functionality to terminate the NR access interface to UEs and next-hop IAB-nodes, and to terminate the F1 protocol to the centralized unit (CU), e.g. gNB-CU, functionality. The gNB-DU functionality on the IAB-node is also referred to as IAB-DU.

In addition to the gNB-DU functionality, the IAB-node also supports a subset of the UE functionality referred to as IAB-MT, which includes, e.g., physical layer, layer-2, RRC and NAS functionality to connect to the gNB-DU of another IAB-node or the IAB-donor, to connect to the gNB-CU on the IAB-donor, and to the core network.

All IAB-nodes that are connected to an IAB-donor via one or multiple hops form a directed acyclic graph (DAG) topology with the IAB-donor as its root. A Parent-and-child-node relationship is defined for IAB-node. In this DAG topology, the neighbour node of the IAB-DU or the IAB-donor-DU is referred to as child node and the neighbour node of the IAB-MT is referred to as parent node. The direction toward the child node is referred to as downstream while the direction toward the parent node is referred to as upstream. The IAB-donor performs centralized resource, topology and route management for the IAB topology.

An IAB node supports the protocol stack for F1-U (user plane) and the protocol stack for F1-C (control plane) between IAB-DU and IAB-donor-CU. F1-U and F1-C may be carried over two backhaul hops since the F1 protocol terminates in the IAB-donor.

On the wireless backhaul, the IP layer is carried over the Backhaul Adaptation Protocol (BAP) sublayer, which enables routing over multiple hops. The IP layer can also be used for non-F1 traffic, such as OAM traffic.

On each backhaul link, the BAP PDUs are carried by BH RLC channels. Multiple BH RLC channels can be configured on each BH link to allow traffic prioritization and QoS enforcement. The BH-RLC-channel mapping for BAP PDUs is performed by the BAP entities on each IAB-node and the IAB-donor-DU.

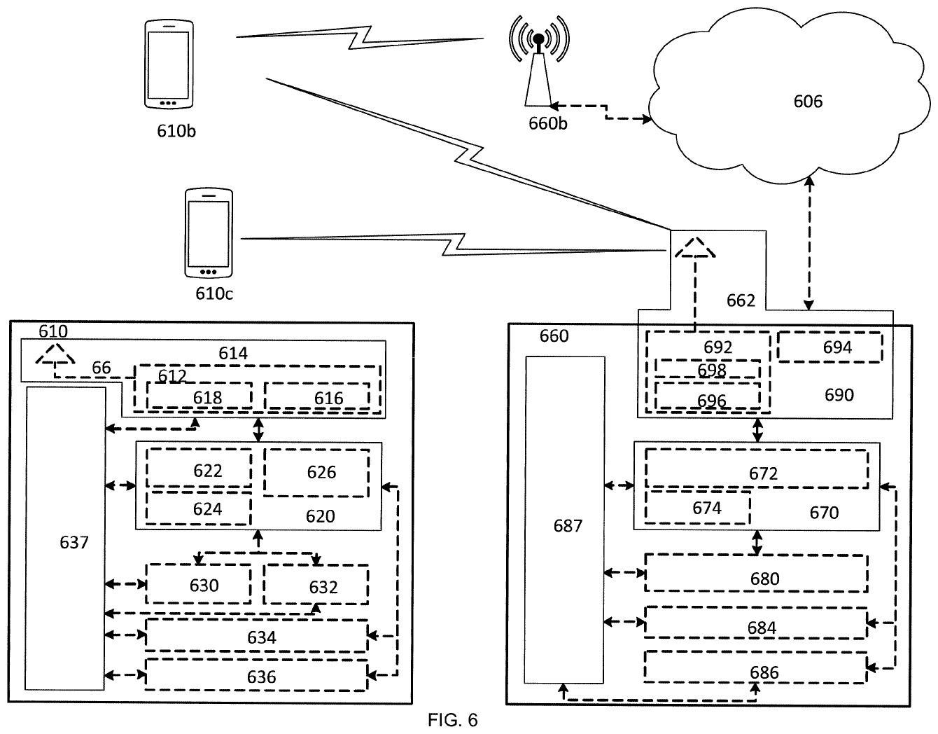

The IAB-MT further establishes SRBs (carrying RRC and NAS) with the IAB-donor-CU. For IAB-nodes operating in ENDC, the IAB-MT also establishes one or more DRBs with the IAB-donor-CU, which can be used, e.g., to carry OAM traffic. For SA mode, the establishment of DRBs is optional. These SRBs and DRBs are transported between the IAB-MT and its parent node over Uu access channel(s). The protocol stacks for the SRB are shown in FIG. 6.

The IAB-DU's IP traffic is routed over the wireless backhaul via the BAP sublayer. In downstream direction, upper layer packets are encapsulated by the BAP sublayer at the IAB-donor-DU and de-encapsulated at the destination IAB-node. In upstream direction, upper layer packets are encapsulated at the IAB-node and de-encapsulated at the IAB-donor-DU.

On the BAP sublayer, packets are routed based on the BAP routing ID, which is carried in the BAP header. The BAP header is added to the packet when it arrives from upper layers, and it is stripped off when it has reached its destination node. The selection of the packet's BAP routing ID is configured by the IAB-donor-CU. The BAP routing ID consists of BAP address and BAP path ID, where the BAP address indicates the destination node of the packet on the BAP sublayer, and the BAP path ID indicates the routing path the packet should follow to this destination. For the purpose of routing, each IAB-node and IAB-donor-DU is further configured with a designated BAP address.

On each hop of the packet's path, the IAB-node inspects the packet's BAP address in the BAP routing ID carried in the packet header to determine if the packet has reached its destination, i.e., matches the IAB-node's BAP address. In case the packet has not reached the destination, the IAB-node determines the next hop backhaul link, referred to as egress link, based on the BAP routing ID carried in the packet header and a routing configuration it received from the IAB-donor-CU.

For each packet, the IAB-node further determines the egress BH RLC channel on the designated egress link. For packets arriving from upper layers the designated egress BH RLC channel is configured by the IAB-donor-CU, and it is based on upper layer traffic specifiers. Since each BH RLC channel is configured with QoS information or priority level, BH-RLC-channel selection facilitates traffic-specific prioritization and QoS enforcement on the BH. For F1-U traffic, it is possible to map each GTP-U tunnel to a dedicated BH RLC channel or to aggregate multiple GTP-U tunnels into one common BH RLC channel. For other than F1-U traffic, it is possible to map UE-associated F1AP messages, non-UE-associated F1AP messages and non-F1 traffic onto the same or separate BH RLC channels.

When packets are routed from one BH link to another, the egress BH RLC channel on the egress BH link is determined based on the mapping configuration between ingress BH RLC channels and egress BH RLC channels provided by the IAB-donor-CU.

In LTE and NR, speed-based scaling of Timer-To-Tigger (TTT) defined for the connected mode and T-Reselection (defined for the idle mode) parameters are introduced. For UEs in the idle mode in LTE and NR, the broadcasted system information can include speed dependent scaling related parameters like T_{CRmax}, N_{CR_M}, N_{CR_H}, T_{CRmaxHyst}, etc. They are defined as follows (specified in 3GPP TS 36.304 V16.3.0 for LTE and specified in 3GPP TS 38.304 V16.3.0 for NR):

### Speed Dependent Reselection Parameters

Speed dependent reselection parameters are broadcast in system information and are read from the serving cell as follows: T_{CRmax}

This specifies the duration for evaluating allowed amount of cell reselection(s).

### N_{CR_M}

This specifies the maximum number of cell reselections to enter Medium-mobility state.

### N_{CR_H}

This specifies the maximum number of cell reselections to enter High-mobility state.

### T_{CRmaxHyst}

This specifies the additional time period before the UE can enter Normal-mobility state.

### Speed Dependent ScalingFactor for Qhyst

This specifies scaling factor for Qhyst in sf-High for High-mobility state and sf-Medium for Medium-mobility state.

### Speed Dependent ScalingFactor for Treselection_{EUTRA}

This specifies scaling factor for Treselection_{EUTRA} in sf-High for High-mobility state and sf-Medium for Medium-mobility state.

The scaling principles used in NR are defined as follows (similar principles apply for LTE):

```
----------------------------- begin excerpt from 3GPP TS 38.304 V16.3.0 --------------------------------
5.2.4.3  Mobility states of a UE
5.2.4.3.0  Introduction
The UE mobility state is determined if the parameters (T_{CRmax}, N_{CR}_H, N_{CR}_M and T_{CRmaxHyst})
are broadcasted in
system information for the serving cell.
State detection criteria:
Normal-mobility state criteria:
  - If number of cell reselections during time period T_{CRmax} is less than N_{CR}_M.
Medium-mobility state criteria:
  - If number of cell reselections during time period T_{CRmax} is greater than or equal to N_{CR}_M but
  less than or equal to N_{CR}_H.
High-mobility state criteria:
  - If number of cell reselections during time period T_{CRmax} is greater than N_{CR}_H.
The UE shall not consider consecutive reselections where a cell is reselected again right after one reselection
for mobility state detection criteria.
State transitions:
The UE shall:
  - if the criteria for High-mobility state is detected:
    - enter High-mobility state.
  - else if the criteria for Medium-mobility state is detected:
  enter Medium-mobility state.
    - else if criteria for either Medium- or High-mobility state is not detected during time period
  T_{CRmaxHyst}:
    enter Normal-mobility state.
If the UE is in High- or Medium-mobility state, the UE shall apply the speed dependent scaling rules as defined
in clause 5.2.4.3.1.
5.2.4.3.1 Scaling rules
UE shall apply the following scaling rules:
  - If neither Medium- nor High-mobility state is detected:
    - no scaling is applied.
  - If High-mobility state is detected:
    - Add the sf-High of “Speed dependent ScalingFactor for Q_{hyst}” to Q_{hyst} if broadcasted in
    system information;
    - For NR cells, multiply Treselection_{NR} by the sf-High of “Speed dependent
    ScalingFactor for Treselection_{NR}” if broadcasted in system information;
    - For EUTRA cells, multiply Treselection_{EUTRA} by the sf-High of “Speed dependent
    ScalingFactor for Treselection_{EUTRA}” if broadcasted in system information.
  - If Medium-mobility state is detected:
    - Add the sf-Medium of “Speed dependent ScalingFactor for Q_{hyst}” to Q_{hyst} if
    broadcasted in system information;
    - For NR cells, multiply Treselection_{NR} by the sf-Medium of “Speed dependent
    ScalingFactor for Treselection_{NR}” if broadcasted in system information;
    - For EUTRA cells, multiply Treselection_{EUTRA} by the sf-Medium of “Speed dependent
    ScalingFactor for Treselection_{EUTRA}” if broadcasted in system information.
In case scaling is applied to any Treselection_{RAT} parameter, the UE shall round up the result after all
scalings to the nearest second.
----------------------------- end excerpt from 3GPP document --------------------------------
```

In case scaling is applied to any Treselection_{RAT} parameter, the UE shall round up the result after all scalings to the nearest second.

The mobility state itself may be a good input for the CU to decide on one or more of the following decisions.
1) What type of handover to configure (legacy, conditional handover, Dual Active Protocol Stack (DAPS))
2) What inter-frequency measurements can be configured to the UE (e.g., avoiding small cells in high frequencies for high speed UEs)
3) Other measurement configurations like Time-To-Trigger, A3 offset, cell individual offset (CIO) etc.
4) Optimization of random-access procedure (for example, by adjusting link adaptation loops)

However, the number of cell reselection/handovers related mobility state estimation has a few drawbacks, including at least the following:
1) There is no mobility state determination in the RRC CONNECTED mode in NR. Currently the UE sends the mobility state (as required to be determined by TS 38.304) in response to an RRCSetup or RRCResume from the gNB.
2) The mobility state estimation is simplistic for example it is difficult to use the same set of parameters to estimate the mobility state in a cell for two different UEs which might have had different past mobility history.
3) The UE's mobility state might change when the UE is in the cell i.e., the past handover/reselection statistics might not be relevant anymore.

Therefore, there is a need for a different approach of estimating the mobility state.

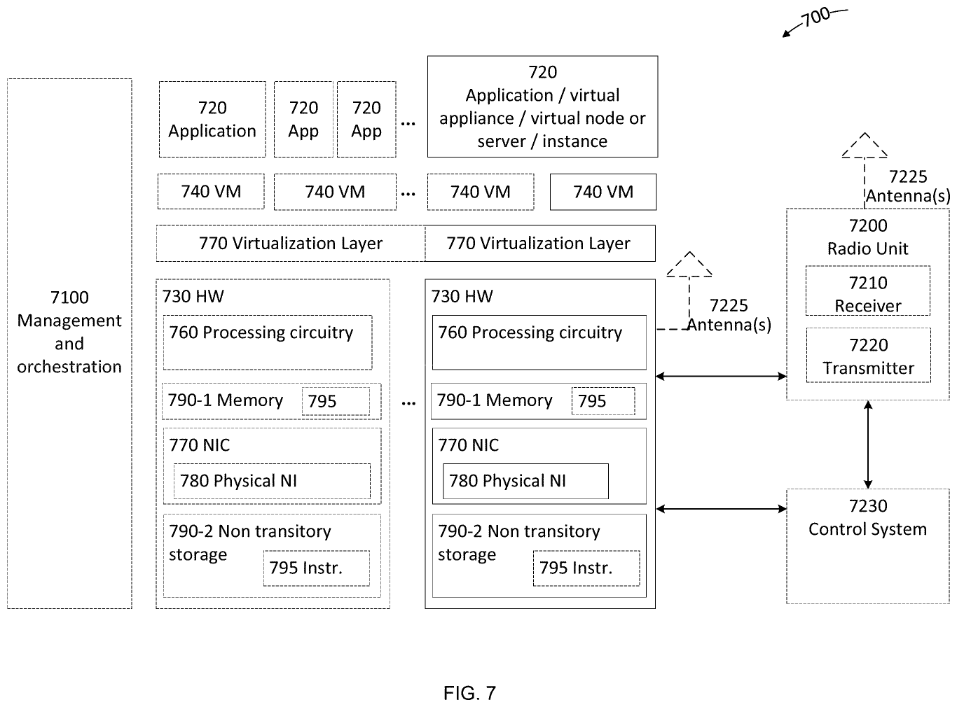

Considering point 2 above in more detail, in an example, one UE might have been handed over to this cell from a mmW frequency cell wherein the four previous handovers of the UE were intra-mmW handovers and another UE might have been handed over to this cell from a low band cell wherein the four previous handovers of that UE were intra-low band handovers. Now, it becomes difficult to use the previous (past) handover statistics to configure the mobility state selection parameters in a generic way. Another reason, as shown in Figure. 7, is that the handover statistics can affect mobility state. For example, the UE1 and UE2 have a similar mobility state in reality but UE2 performs many more cell changes than UE2 which may suggest it has a higher mobility state.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. In particular, a network node may be comprised in a non-terrestrial network as part of a wireless communications system. A non-terrestrial network (NTN) comprises communications satellites and network nodes. The network nodes may be terrestrial or satellite based. For example, the network node may be a satellite gateway or a satellite based base station, e.g. gNB. Other examples of network nodes include, but are not limited to, access points (APs) (e.g., radio access points), base stations (BSs) (e.g., radio base stations, Node Bs, evolved Node Bs (eNBs) and NR NodeBs (gNBs)) and IAB nodes. Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In particular the wireless device may be involved in communication with a non-terrestrial network nodes, such as communications satellites and satellite based gateways or base stations. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

In the below description, mobility state is used broadly as it refers not only to the speed of the UE but the direction of the UE's mobility, for example, may also be included in this regard.

In certain embodiments the CU may request the DU to perform the mobility state estimation procedure. This procedure is an optional step, for example, in other embodiments the DU may be configured to perform this at certain time intervals or based on other internal triggers.

As part of the request, the CU may request the DU to provide mobility state estimation for a specific UE. In other examples the request may apply to a set of UEs.

In some examples the request from the CU includes a reporting periodicity for the mobility state. The DU reports the mobility state of the UE with this periodicity to the CU.

In some examples the request from the CU comprises a one shot request i.e., the DU reports the mobility state of a UE once to the CU associated to the particular request.

In some examples the request includes CU configuring certain event configuration to the DU. Upon fulfilling the event condition, the DU sends the mobility state report to the CU. The event may comprise one or more of the following (other similar events are not precluded):
When the estimated mobility state of a UE changes in any way (for example, from low to medium or from medium to high or medium to low etc.)
When the estimated mobility state of a UE changes to according to a specific requirement, for example to one of high/low/medium. For example, the event could be ‘when the UE goes to high mobility state’. If the UE changes from low to medium, then the DU would have sent a notification based on the previous condition but not according to the present condition.
When a UE changes direction with by certain amount (e.g. estimated angle) or changes from one direction to another direction within a set of predefined directions, for example ±x, ±y, ±z, ±v, etc.

In some examples the request includes the CU requesting the DU to predict the speed or mobility state for at least one UE, for a certain period of time in advance, using a machine learning model.

In some examples any combination or all combinations of the above examples are comprised in the request.

In some examples the request includes the CU requesting the DU to send information related to the UE speed. Non limiting example of such information can be:
i) Timing advance value measured based on the UE uplink signals. In some examples this is the actual value. In other examples this is a statistical value such as averaged timing advanced values or max/min/median values.
ii) Doppler shift value measured based on the UE uplink signals. Again, in some examples this is the actual value. In other examples this is a statistical value such as averaged timing advanced values or max/min/median values.
iii) index of the beams switched by the UE and the order of the switched beams.

In some examples the DU estimates the UE speed based on one or more methods. For example, the DU may estimates the mobility state of the UE based on one or more parameters, such as Doppler shift in the UL signals sent by the UE, Timing advance measured in the UL signals sent by the UE (for example Timing advance configured to the UE based on the UL signals), Number of beam switchings and/or the order of switched beams, Angle of arrival of the uplink signals sent by the UE. For example, this is may be based on the DL configurations used by the DU towards the UE either for DL control signaling or DL data transmission. In some examples the mobility state changes maybe estimated based on the change in the beam patterns used towards this UE.

The parameters mentioned above regarding what information is used by the DU to compute the mobility state of the UE is not considered to be exclusive i.e., DU could derive the mobility state based on any other available information at the DU about this UE, without deviating from the inventive concepts described herein.

In some examples the DU estimates the mobility state of the UE based on the rate of change of DL beamforming changes towards the UE. In the analog beamforming case, this may be determined based on the rate of change of CSI-RS beams used for data transmission. Whereas, in the digital/hybrid beamforming case, the DU may determine the mobility state based on the rate of change of beamforming vectors and the range of changes in the beamforming vectors.

In some examples the DU may use a Machine Learning (ML) model to predict the UE speed or mobility state in advance and send the predicted value of the UE speed or UE mobility state to the network. Some non-limiting examples of the inputs/features to the used for training the model are:
Doppler shift in the UL signals sent by the UE.
Timing advanced measured in the UL signals sent by the UE
Number of beam switching and the order of switched beams
angle of arrival of the uplink signals sent by the UE
UE location information
Actual speeds collected by e.g., MDT measurements and sent from CU to the DU.
UE sensor information (for example this could include an interial measurement unit (IMU) sensor based measurements, an example of this may be as included in TS 38.331 v16.2.0 by information element “Sensor-LocationInfo”.
Time stamps, for example, time stamps associated to the RRM measurements sent by the UE. In some examples, if the UE sends the following measurements: Time=T; serving RSRP=100 dBm and Time=T+2 seconds; serving RSRP=90 dBm and Time=T+4 seconds; serving RSRP=75 dBm this would be an indication that the UE was moving very fast as the rate at which the RSRP of a cell as measured by the UE is changing rapidly.
Mobility state information reported by the UE

The DU may use the estimated mobility state to classify the UE as belonging to a certain range of mobility, for example one of a ‘low’, ‘medium’ or ‘high’ mobility state. Obviously, these are just examples and further granularity may be applied e.g., ‘very slow’. The DU may use the estimated mobility state to classify the UE's direction of mobility to be belonging to a certain direction or group of directions, for example different ranges of directions may be denominated ‘X’, ‘Y’ or ‘Z’ directions.

Upon reception of the CU request to estimate the UE mobility state for at least one UE, the DU may send the estimated UE speed or UE mobility state to the CU.

In some examples, if the DU is requested to send the estimated speed or estimated mobility state in a periodic way, for example, at every T units (e.g., T seconds or T minutes) of time, DU sends to the CU the estimated speed or estimated mobility state for at least one UE based on the pre-set period of time.

In another example, if the DU is requested to send a one-shot estimation of the speed or mobility state for at least one UE, the DU sends to the CU the estimated speed or the estimated mobility state to the CU for at least one UE. In some examples the DU may return a previously estimated speed or mobility state (for example if such estimation is performed periodically). In some examples the information is then returned directly, e.g. in an Ack type response to the request from the CU. In other examples the information may be returned in a separate reporting type message. In such cases where the estimation is performed as a result of the request then the information may be returned as a reporting type message.

If the DU received a request to send estimated speed or mobility state of at least one UE upon triggering specific conditions, for example, with pre-defined thresholds (or other non-limiting examples as explained herein), the DU sends the estimated speed or mobility state when the conditions for the predefined thresholds are met.

In another aspect, the DU may be requested to predict a future value of the UE speed or mobility state. In such a case, the DU sends to the CU the predicted value of the UE speed or UE mobility state. In some examples the DU may provide the predicted data in a response message, for example if the DU is determining future UE speed or mobility state. In other examples the DU is triggered to perform such a determination and responds with the data in a report type message.

In another example the DU may be requested or configured to send measurements such as a Timing Advance value or Doppler shift values or the ordered beams indexes switched by the UE. In such a case, the DU sends the corresponding measurements for at least one UE to the CU.

The request from the from CU to the DU in all the above embodiments is optional; in some aspects the DU sends the estimated or predicted value of the UE speed or mobility state to the CU independently, for example, as periodical reporting or based on a pre-configured threshold or trigger e.g., change of UE mobility state.

When the CU receives the UE speed or mobility state information, the CU may take one or actions based on the reported mobility state. In general terms the CU may perform a handover or may make further configurations in relation to the resource management associated with the UE or plurality of UEs. For example, the CU may choose between different types of handover configuration based on the reported mobility state. A legacy handover is performed directly on receipt of a specific handover command from the serving cell. An alternative type of handover is conditional handover. A Conditional Handover (CHO) is defined as a handover that is executed by the UE when one or more handover execution conditions are met. The UE starts evaluating the execution condition(s) upon receiving the CHO configuration, and stops evaluating the execution condition(s) once a handover is executed (legacy handover or conditional handover execution). For example certain principles may apply to CHO, such as the CHO configuration contains the configuration of CHO candidate cell(s) generated by the candidate gNB(s) and execution condition(s) generated by the source gNB; an execution condition may consist of one or two trigger condition(s) (CHO events); only single reference signal (RS) type is supported and at most two different trigger quantities (e.g. RSRP and RSRQ, RSRP and SINR, etc.) can be configured simultaneously for the evaluation of CHO execution condition of a single candidate cell; before any CHO execution condition is satisfied, upon reception of HO command (without CHO configuration), the UE executes the HO procedure regardless of any previously received CHO configuration; and while executing CHO, i.e. from the time when the UE starts synchronization with target cell, UE does not monitor source cell. Another type of handover is a Dual Active Protocol Stack (DAPS) Handover which is a handover procedure that maintains the source gNB connection after reception of RRC message for handover and until releasing the source cell after successful random access to the target gNB.

More specifically, handover related actions may comprise:
When the reported mobility state is ‘low’, the CU initiates a normal handover procedure towards this UE.
When the reported mobility state is ‘high’, the CU initiates a conditional handover procedure towards this UE.
When the reported mobility state is ‘low’, the CU initiates a DAPS intra-frequency handover procedure towards this UE, provided the UE supports DAPS handover.
When the reported mobility state is ‘high’, the CU initiates a DAPS inter-frequency handover procedure towards this UE, provided the UE supports DAPS handover.
When the reported mobility direction is ‘X’ and speed to be ‘low’, the CU initiates the handover procedure towards a target cell from a first set of cells for this UE.
When the reported mobility direction is ‘X’ and speed to be ‘high’, the CU initiates a conditional handover procedure (for example, when the neighbour cell becomes ‘X’ dB better than the serving cell) towards a target cell from a first set of cells for this UE.
When the reported mobility direction is ‘Y’ and speed to be ‘low’, the CU initiates the handover procedure towards a target cell from a second set of cells for this UE.
When the reported mobility direction is ‘Y’ and speed to be ‘high’, the CU initiates a conditional handover procedure towards a target cell from a second set of cells for this UE.

In some examples, the selection of the set of cells is not only dependent on the direction but also the speed. For example, if there are two UEs going in the same direction but one being a low speed UE (pedestrian walker) and the other being a high speed UE (train user), then first user could be handed over to a small cell (micro/pico cell) whereas the second user could be handed over to a macro cell and thus avoid handing over to a small cell when the CU knows that the UE would require another handover in a short period if the UE had been handed over to a small cell.

In other examples, the CU performs certain radio resource management procedures in response or based on the received information from the DU. More specifically, for example:
When the reported mobility state is ‘low’, the CU does not configure the UE with reporting configurations associated to conditional handover;
When the reported mobility state is ‘high’, the CU configures the UE with reporting configurations associated to conditional handover;
When the reported mobility is ‘high’, the CU configures a lower number of the measurement objects related to high frequencies (e.g., mmW), The reason for this is that the high frequency cell coverage area is small and thus high speed UEs stay for very short time in such cells;
When the reported mobility is ‘high’, the CU configures a lower number of the measurement objects related to frequencies where only small (e.g., micro/pico/femto) cells are deployed.

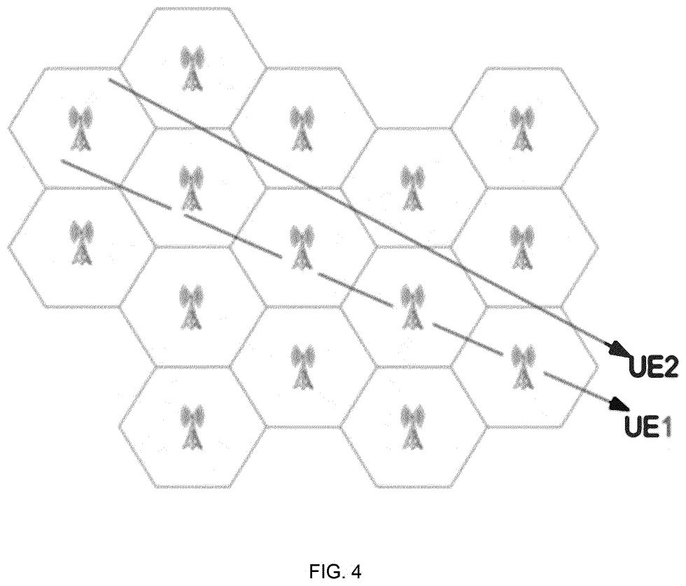

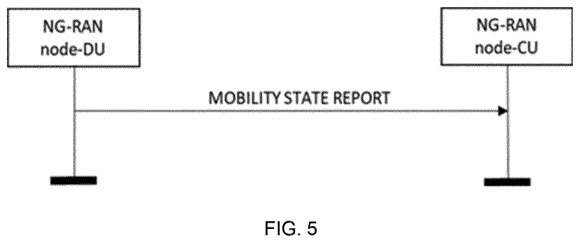

As described above the reporting of the mobility state information may be in a response message, in particular if the CU performs a request and such information is available as a response to such request. In other examples the mobility state information (e.g. UE speed information) is provided to the CU with a reporting message. In some examples this may be a dedicated message for this information. An example signal flow is depicted in FIG. 5. In terms of specifying such a procedure in a standardization specification, for example, in a radio resource control (RRC) or F1 application protocol (F1-AP) protocol the message may be defined in the following format:

### Mobility State Report

This message is sent by the gNB-DU to inform the gNB-CU about the mobility state of a list of UEs.
Direction: gNB-DU→gNB-CU.

TABLE 1

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| Transaction ID | 5 | | 9.3.1.23 | | YES | reject |
| Mobility State Report | | 0 . . . 1 | | | YES | ignore |
| Information | | | | | | |
| >Mobility State Report | | 1 . . . | | | EACH | ignore |
| Item | | <maxno | | | | |
| | | ofMobilit | | | | |
| | | yState> | | | | |
| >>Mobility State | O | | ENUMARATED | | YES | ignore |
| Report | | | (Low, Mid, High, . . . ) | | | |
| >>gNB-CU UE F1AP | O | | 9.3.1.4 | | YES | reject |
| ID | | | | | | |
| >>gNB-DU UE F1AP | O | | 9.3.1.5 | | YES | reject |
| ID | | | | | | |

| | |
|---|---|
| Range bound | Explanation |
| maxnoofMobilityState | Maximum no. of mobility state reports, the maximum value is X. |

In some examples the so introduced ‘mobility state information’ or ‘mobility state report’ may be included in a handover request message from the source CU to a target DU at the time of sending the handover request message.

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and wireless devices 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and wireless device 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. In addition, or alternatively to the aforementioned separation of the network node into DU and CU functions, a network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660.

Device readable medium 680 may be used to store any calculations made by processing circuitry 670 and/or any data received via interface 690. In some embodiments, processing circuitry 670 and device readable medium 680 may be considered to be integrated. Interface 690 is used in the wired or wireless communication of signalling and/or data between network node 660, network 606, and/or wireless devices 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or wireless devices via a wireless connection. Radio front end circuitry 692 may convert the digital data into a radio signal having the appropriate channel and bandwidth parameters using a combination of filters 698 and/or amplifiers 696.

The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. wireless device 610 may include multiple sets of one or more of the illustrated components for different wireless technologies supported by wireless device 610, such as, for example, GSM, WCDMA, LTE, NR, WiFi, WiMAX, or Bluetooth wireless technologies, just to mention a few. These wireless technologies may be integrated into the same or different chips or set of chips as other components within wireless device 610.

Antenna 611 may include one or more antennas or antenna arrays, configured to send and/or receive wireless signals, and is connected to interface 614. In certain alternative embodiments, antenna 611 may be separate from wireless device 610 and be connectable to wireless device 610 through an interface or port. Antenna 611, interface 614, and/or processing circuitry 620 may be configured to perform any receiving or transmitting operations described herein as being performed by a wireless device. Any information, data and/or signals may be received from a network node and/or another wireless device. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, wireless device 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or wireless devices via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 610 components, such as device readable medium 630, wireless device 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of wireless device 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620. In certain embodiments, some or all of the functionality described herein as being performed by a wireless device may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of wireless device 610, but are enjoyed by wireless device 610 as a whole, and/or by end users and the wireless network generally. Processing circuitry 620 may be configured to perform any determining, calculating, or similar operations (e.g., certain obtaining operations) described herein as being performed by a wireless device. These operations, as performed by processing circuitry 620, may include processing information obtained by processing circuitry 620 by, for example, converting the obtained information into other information, comparing the obtained information or converted information to information stored by wireless device 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with wireless device 610. Such interaction may be of many forms, such as visual, audial, tactile, etc. User interface equipment 632 may be operable to produce output to the user and to allow the user to provide input to wireless device 610. The type of interaction may vary depending on the type of user interface equipment 632 installed in wireless device 610. For example, if wireless device 610 is a smart phone, the interaction may be via a touch screen; if wireless device 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into wireless device 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from wireless device 610, and to allow processing circuitry 620 to output information from wireless device 610. User interface equipment 632 may include, for example, a speaker, a display, vibrating circuitry, a USB port, a headphone interface, or other output circuitry. Using one or more input and output interfaces, devices, and circuits, of user interface equipment 632, wireless device 610 may communicate with end users and/or the wireless network, and allow them to benefit from the functionality described herein.

Auxiliary equipment 634 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. wireless device 610 may further comprise power circuitry 637 for delivering power from power source 636 to the various parts of wireless device 610 which need power from power source 636 to carry out any functionality described or indicated herein. Power circuitry 637 may in certain embodiments comprise power management circuitry. Power circuitry 637 may additionally or alternatively be operable to receive power from an external power source; in which case wireless device 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of wireless device 610 to which power is supplied.

FIG. 7 is a schematic block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 700 hosted by one or more of hardware nodes 730. Further, in embodiments in which the virtual node is not a radio access node or does not require radio connectivity (e.g., a core network node), then the network node may be entirely virtualized. The functions may be implemented by one or more applications 720 (which may alternatively be called software instances, virtual appliances, network functions, virtual nodes, virtual network functions, etc.) operative to implement some of the features, functions, and/or benefits of some of the embodiments disclosed herein. Applications 720 are run in virtualization environment 700 which provides hardware 730 comprising processing circuitry 760 and memory 790. Memory 790 contains instructions 795 executable by processing circuitry 760 whereby application 720 is operative to provide one or more of the features, benefits, and/or functions disclosed herein.

Virtualization environment 700, comprises general-purpose or special-purpose network hardware devices 730 comprising a set of one or more processors or processing circuitry 760, which may be commercial off-the-shelf (COTS) processors, dedicated Application Specific Integrated Circuits (ASICs), or any other type of processing circuitry including digital or analog hardware components or special purpose processors. Each hardware device may comprise memory 790-1 which may be non-persistent memory for temporarily storing instructions 795 or software executed by processing circuitry 760. Each hardware device may comprise one or more network interface controllers (NICs) 770, also known as network interface cards, which include physical network interface 780. Each hardware device may also include non-transitory, persistent, machine-readable storage media 790-2 having stored therein software 795 and/or instructions executable by processing circuitry 760. Software 795 may include any type of software including software for instantiating one or more virtualization layers 750 (also referred to as hypervisors), software to execute virtual machines 740 as well as software allowing it to execute functions, features and/or benefits described in relation with some embodiments described herein.

Virtual machines 740, comprise virtual processing, virtual memory, virtual networking or interface and virtual storage, and may be run by a corresponding virtualization layer 750 or hypervisor. Different embodiments of the instance of virtual appliance 720 may be implemented on one or more of virtual machines 740, and the implementations may be made in different ways.

During operation, processing circuitry 760 executes software 795 to instantiate the hypervisor or virtualization layer 750, which may sometimes be referred to as a virtual machine monitor (VMM). Virtualization layer 750 may present a virtual operating platform that appears like networking hardware to virtual machine 740.

As shown in FIG. 7, hardware 730 may be a standalone network node with generic or specific components. Hardware 730 may comprise antenna 7225 and may implement some functions via virtualization. Alternatively, hardware 730 may be part of a larger cluster of hardware (e.g. such as in a data center or customer premise equipment (CPE)) where many hardware nodes work together and are managed via management and orchestration (MANO) 7100, which, among others, oversees lifecycle management of applications 720. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 740 may be a software implementation of a physical machine that runs programs as if they were executing on a physical, non-virtualized machine. Each of virtual machines 740, and that part of hardware 730 that executes that virtual machine, be it hardware dedicated to that virtual machine and/or hardware shared by that virtual machine with others of the virtual machines 740, forms a separate virtual network elements (VNE).

Still in the context of NFV, Virtual Network Function (VNF) is responsible for handling specific network functions that run in one or more virtual machines 740 on top of hardware networking infrastructure 730 and corresponds to application 720 in FIG. 7.

In some embodiments, one or more radio units 7200 that each include one or more transmitters 7220 and one or more receivers 7210 may be coupled to one or more antennas 7225. Radio units 7200 may communicate directly with hardware nodes 730 via one or more appropriate network interfaces and may be used in combination with the virtual components to provide a virtual node with radio capabilities, such as a radio access node or a base station.

In some embodiments, some signalling can be effected with the use of control system 7230 which may alternatively be used for communication between the hardware nodes 730 and radio units 7200.

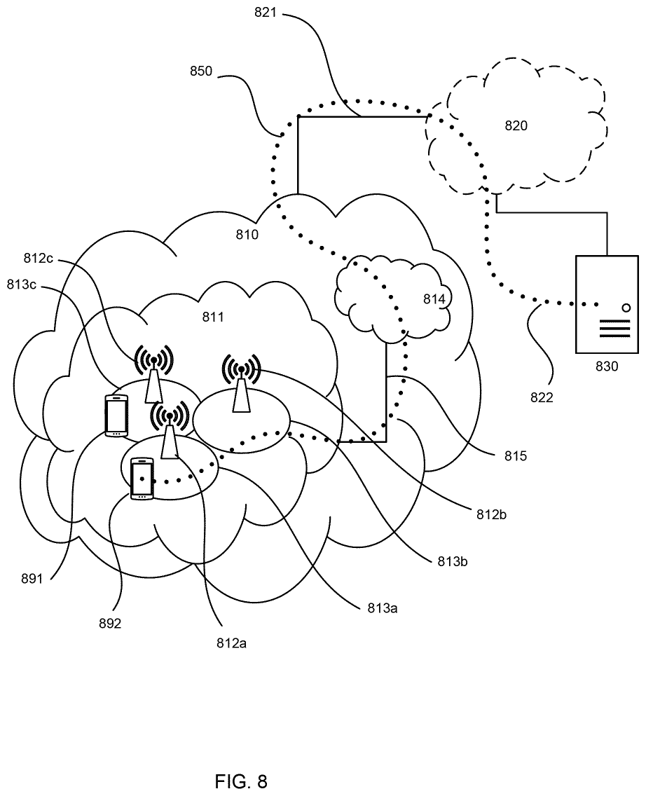

With reference to FIG. 8, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider, or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 8 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

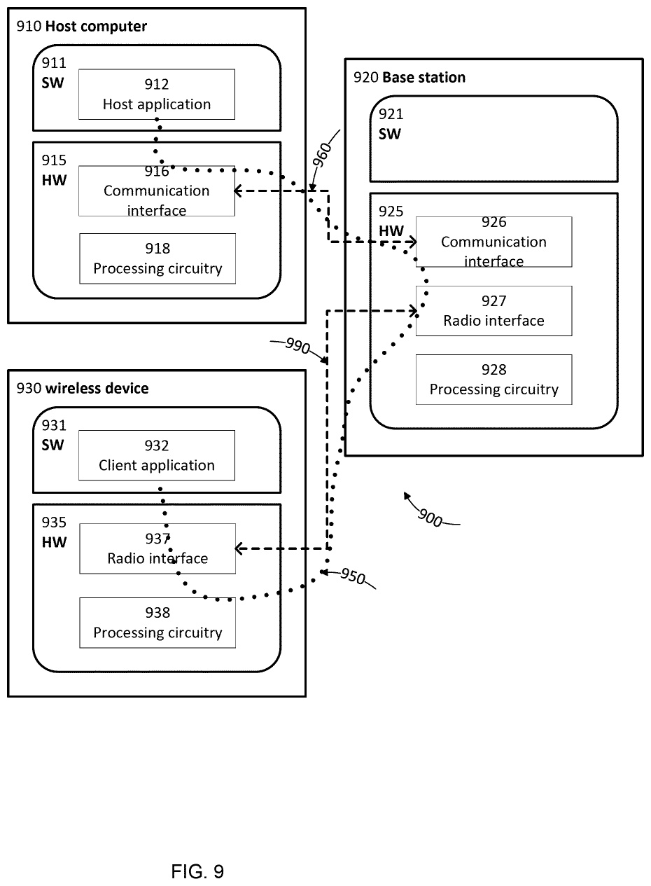

Example implementations, in accordance with an embodiment, of the UE, base station and host computer discussed in the preceding paragraphs will now be described with reference to FIG. 9. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage area (not shown in FIG. 9) served by base station 920. Communication interface 926 may be configured to facilitate connection 960 to host computer 910. Connection 960 may be direct or it may pass through a core network (not shown in FIG. 9) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 9 may be similar or identical to host computer 830, one of base stations 812a, 812b, 812c and one of UEs 891, 892 of FIG. 8, respectively. This is to say, the inner workings of these entities may be as shown in FIG. 9 and independently, the surrounding network topology may be that of FIG. 8.

In FIG. 9, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may improve the latency and reliability of certain services, in particular those relying on the integrity of the radio connection whilst running on a non-static wireless device. In particular, at least some embodiments will provide optimised handover/cell changes based on dynamic mobility state information during the life of the connection and ongoing service.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above, or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

In some examples the communication system including a host computer comprising a communication interface configured to receive user data originating from a transmission from a user equipment (UE) to a first and or a second network node of a radio access network, wherein the first and second network node comprise a radio interface and processing circuitry, the first and second network node's processing circuitry configured to perform any of the steps of any of the embodiments described herein, in relation to the respective first or second network node. In some examples the processing circuitry of the host computer is configured to execute a host application and the UE is configured to execute a client application associated with the host application, thereby providing the user data to be received by the host computer.

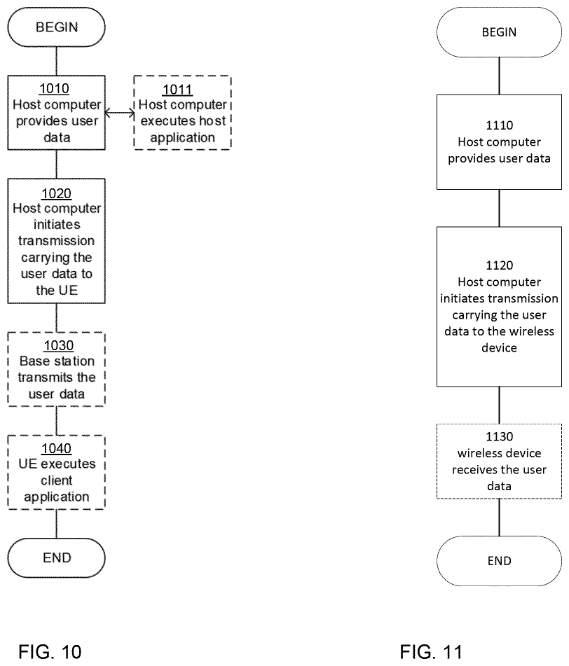

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

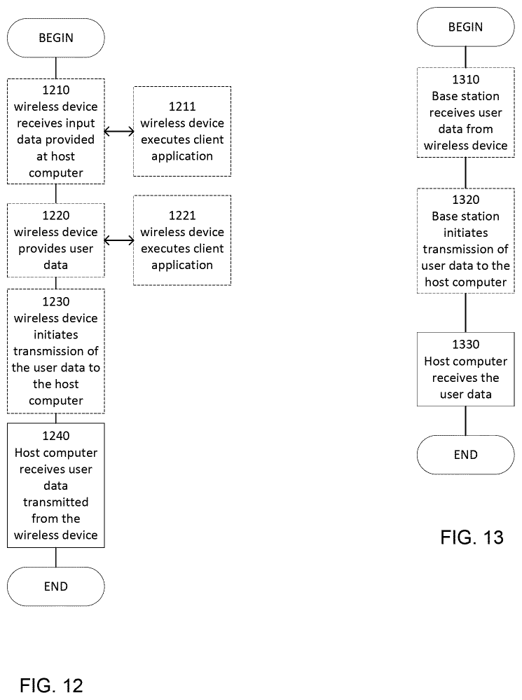

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

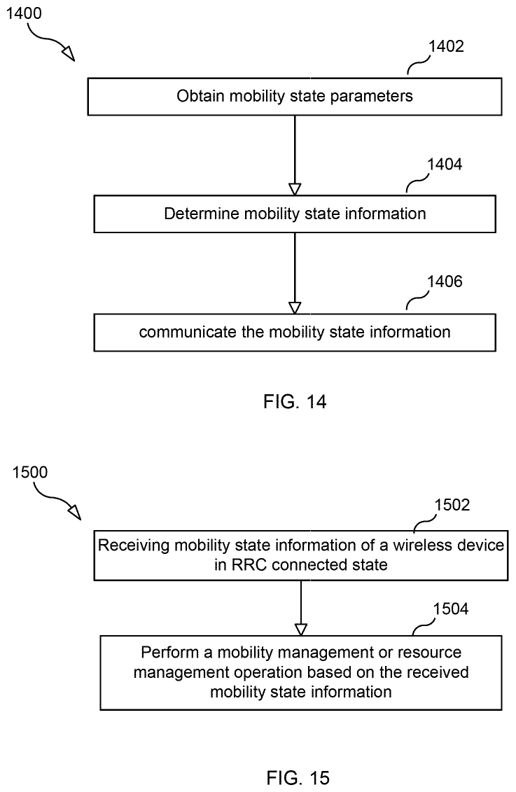

FIG. 14 illustrates an example method 1400 performed by a first network in a radio access network. The method relates to the mobility state of a wireless device which is in a connected mode with the radio access network of which the first network node is a physical or logical part. For example, the wireless device has successfully performed an RRC setup or establishment procedure. The term mobility state information encompasses various levels of granularity and types of mobility information depending on the embodiments. For example in some embodiments the mobility state information comprises the same information as described above for the mobility state IE, specified in TS 38.304 or TS 36.304. In other embodiments the mobility state information comprises values or parameters introduced herein.

The method comprises obtaining 1402 one or more mobility state related parameters and determining 1404 a mobility state information of the wireless device based on the one or more mobility state related parameters. The method proceeds with communicating 1406 the determined mobility state information to a second network node, for example a CU entity within the radio access network. The method is described for a wireless device which is not limited to a singular wireless device, in some examples a plurality of wireless devices may be reported, for example if served by a certain cell or grouped in any other way. In some examples of this aspect the mobility state comprises at least one of mobility state information such as direction of movement and speed information of the wireless device. For example, the mobility state information may comprise previously defined mobility state information defined in radio resource control protocol for signalling during a RRC establishment or in other examples the mobility state information may comprise additional parameters related to the speed of the wireless device. In some examples of this aspect the obtained one or more mobility state related parameters are comprised in or obtained or derived from an uplink signal received from the wireless device, some non-limiting examples being a reference signal transmission, measurement report, uplink control information, HARQ. In addition or alternatively the obtained one or more mobility state related parameters are comprised in or obtained or derived from information related to downlink reference signals transmitted to the wireless device. In some examples the mobility state may be obtained through processing previously stored mobility data of the wireless device. For example, a separate application or function may apply machine learning to determine or predict a mobility state based on collected data related to the wireless device. The mobility state obtained by processing previously stored mobility data may comprise wireless device speed and/or mobility state information obtained from a machine learning entity based on at least one of: a doppler shift in the UL signals sent by the wireless device; a timing advanced measured in the uplink signals sent by the wireless device; a number of beam switches and the order of switched beams; an angle of arrival of the uplink signals sent by the wireless device; the wireless device location information; actual speeds of the wireless device; wireless device sensor information; time stamps; and mobility state information reported by the wireless device.

In some examples the obtained one or more mobility state related parameters comprises one or more of: a doppler shift in the uplink signals sent by the wireless device; a timing advanced measured in the uplink signals sent by the wireless device; a number of beam switches and/or the order of switched beams; and an angle of arrival of uplink signals sent by the wireless device. The obtained one or more mobility state related parameters may be based on a rate of change of DL beamforming changes towards the wireless device. In some examples for analogue beamforming the one or more parameters are determined based on the rate of change of CSI-RS beams used for data transmission. In other examples, for digital/hybrid beamforming, the one or more parameters are determined based on the rate of change of beamforming vectors and the range of changes in the beamforming vectors.

In some examples the first network node determines one or more of the mobility state related parameters itself, in other words the parameters are obtained by the first network node determining the parameters for example based on historic data, received signalling etc.

In some examples of the method 1400 the communicated mobility state comprises a classification of the wireless device mobility state as a relative level of mobility. In addition or alternatively the mobility state comprises a classification of the direction of the wireless device into one of a predefined set of directions.

In some examples the method further comprises determining the mobility state periodically. In some examples the method further comprises communicating the determined mobility state information to the second network node periodically. In other examples both the determining step and the communicating step are performed periodically; the periods may or may not be the same. For example the communicating period may be longer or less frequent than the determining period. In some examples the determined mobility state may be communicated to the second network node upon satisfying a certain criterion or criteria. For example the mobility state information is only communicated once it reaches or exceeds a certain threshold.

In some examples the method may further comprising determining a predicted value of the wireless device speed or other mobility state information such as predicted direction of movement and communicating the mobility state information based on the predicted value. In some examples one or more of the obtained mobility state parameters are communicated to the second network node, for example a mobility state information may be determined and in addition certain parameters included in the signalling or report to the second network node, for example the mobility state information may have a large granularity or grouping and in addition a particular mobility state parameter such as a speed value may be included.

In some examples the method further comprises receiving a request for the mobility state information from the second network node. In some examples therefore, the communication comprises a response to the request.

The first network node performing the method may be a distributed unit, such as gNB-DU and the second network node a centralized unit, such as a gNB-CU. In further examples the first network node is an integrated access and backhaul distributed unit (IAB-DU) and the second network node is an integrated access and backhaul centralized unit (IAB-CU). In some examples, therefore, the radio access network comprises a plurality of IAB nodes providing the access and backhaul functionality.

In some examples the mobility state information is communicated in a mobility state information message for example in radio resource control protocol or within an F1 application protocol (F1-AP). For example, the F1AP message may be an existing message whereby a new information element is added to carry the mobility state information between the DU and CU entities. In another example, a new F1AP message, e.g. Mobility State Report which then carries at least an information element comprising the mobility state information. In other examples the mobility state information IE is part of a Mobility State procedure, for example the CU sends a Mobility State Request message and the DU returns a Mobility State Response message containing a mobility state information IE.

In FIG. 15 an example method 1500 is depicted. The method 1500 is performed by a second network node in a radio access network. The radio access network may be comprised in a communication system in which the radio access network supports the connectivity and communication between a plurality of wireless devices.

The method 1500 comprises receiving 1502 a mobility state information from a first network node for a wireless device which is in a connected mode with the radio access network. For example, the wireless device has successfully performed an RRC setup or establishment procedure. The method is described for a wireless device which is not limited to a singular wireless device, in some examples a plurality of wireless devices may be reported, for example if served by a certain cell or grouped in any other way. The method proceeds with the second network node performing 1504 a mobility management operation such as a handover or cell change with the wireless device based on the received mobility state. In other examples the second network node may perform 1504 a radio resource management operation such as, but not limited to, adapting the radio links available for the wireless device, or modifying a modulation and coding scheme or configuring measurement reporting. In some examples the measurement reporting is related to different mobility management operations, such as a type of handover or cell selection/re-selection.

In some examples the second network node performs a normal or legacy handover with the at least one wireless device based on the received mobility state information. This may be termed a “non-conditional” handover in order to distinguish it from the conditional handover (CHO) procedure. In other examples the second network node performs a conditional handover with the wireless device based on the received mobility state information. In yet further examples based on the received mobility state information the second network node may perform a dual active protocol stack, DAPS, handover.

In some examples the mobility state information comprises a direction classification, such as direction of movement and/or a speed classification and then if a handover is performed the type of handover is selected based on the direction and/or speed classification.

In some examples, the mobility state information comprises a direction of movement classification and the handover is then performed to a target cell from a subset of available cells based on the direction classification. The second network node may configure the at least one wireless device with radio resource management configurations based on the received mobility state.

In some examples the second network node configures the wireless device with reporting configurations associated to a normal or non-conditional handover when the reported mobility state is classified as ‘low’. The classification may be further described as having a first level of mobility wherein the first level of mobility has a lower mobility level than a second level of mobility This would be for a normal or legacy handover, in other words when the mobility state information is classified with the first level of mobility no conditional handover is performed. In other examples the second network node configures the wireless device with reporting configurations associated to conditional handover when the reported mobility state is classified with the second level of mobility. For example the second level of mobility is associated with a higher level of mobility when compared with the first level of mobility. In some examples the mobility state information is classified as ‘high’. In other examples the second network node configures fewer measurement objects related to high frequencies compared to the number of measurement objects for lower frequencies. In some examples the second network node configures fewer measurement objects related to frequencies where only small cells are deployed compared to the number of measurement objects for normal or large cells. In some examples the second network node is a centralized unit and the first network node is a distributed unit. In other examples the second network node is an integrated access and backhaul centralized unit and the first network node is an integrated access and backhaul distributed unit.

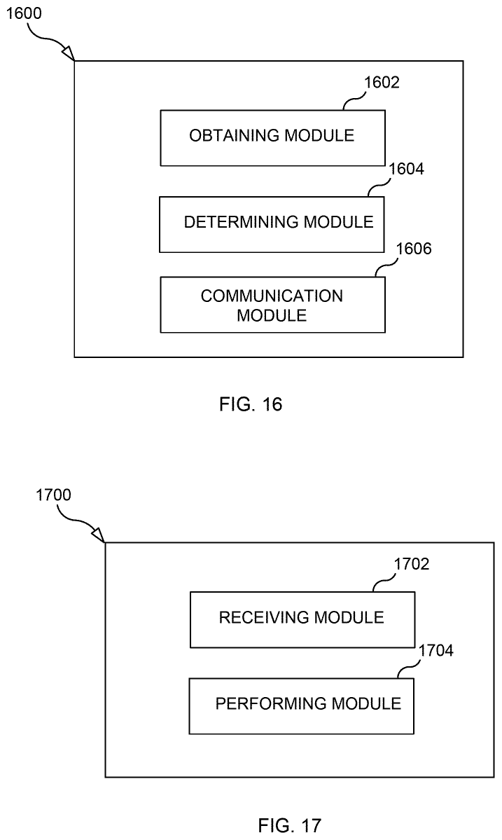

FIGS. 16 and 17 illustrate functional units in other embodiments of a DU entity 1600 and a CU entity 1700, which may execute any of the related methods described herein, for example according to computer readable instructions received from a computer program. It will be understood that the modules illustrated in FIGS. 16 and 17 may be software implemented functional units, and may be realised in any appropriate combination of software modules.

FIG. 16 provides an example DU entity 1600 wherein the DU entity comprises an obtaining module 1602 for obtaining one or more mobility state related parameters and a determining module 1604 for determining a mobility state of one or more wireless devices based on the one or more mobility state related parameters. The DU entity further comprises a communication module 1606 for communicating the determined mobility state to a second network node, for example a CU entitiy.

FIG. 17 provides an example CU entity 1700 wherein the CU entity comprises a receiving module 1702 for receiving a mobility state and a performing module 1704 for performed a process such as a handover or radio resource management operation based on the received mobility state. The CU entity may comprise further modules not illustrated in FIG. 17 to execute the operations directed by the performing module 1704, for example signalling to other network entities and or a wireless device

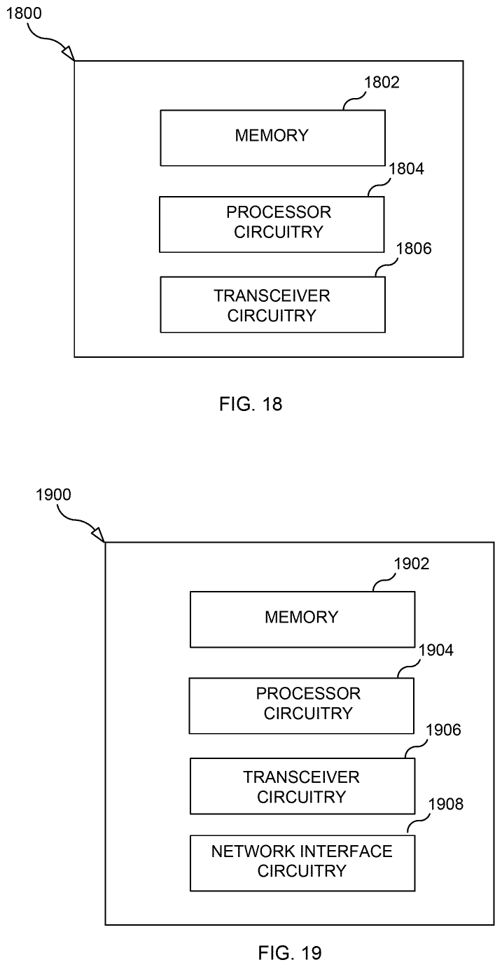

FIGS. 18 and 19 show an example DU apparatus 1800, and CU apparatus 1900, and a that can be adapted or configured to operate according to one or more of the non-limiting example embodiments described.

In FIG. 18 a first network node, which in some examples is a DU entity, 1800 comprises a memory 1802, processor circuitry 1804 that controls the operation of the DU apparatus 1800. The processor circuitry 1804 is connected to transceiver circuitry 1806 which provides wireless connectivity to other nodes in the system, enabling the first network node to send and receive transmissions carrying control and data signals. For example the first network node may use the transceiver circuitry 1806 to communicate with a second network node, for example a CU entity or with child IAB nodes or with served wireless devices. The memory or memory circuitry 1802 may be connected to the processor circuitry 1804 directly or indirectly and that contains instructions or computer program code executable by the processor circuitry 1804 and other information or data required for the operation of the first network node in accordance with the methods described herein. The first network node may be configured to perform any one of the methods described herein. In some aspects the processor circuitry 1804 is configured to obtain one or more mobility state related parameters. In some examples the first network node obtains the one or more mobility state related parameters via one or more signals received via the transceiver circuitry 1806. In this aspect the processor circuitry 1804 determines a mobility state information of a wireless device which is in a connected mode with a radio access network of which the first network node is a part, based on the one or more mobility state related parameters. The processing circuitry 1804 is further configured to communicate (1206), via the 1806 transceiver circuitry, the determined mobility state information to a second network node, for example a CU entity.

In FIG. 19 a second network node, which in some examples is a CU entity, 1900 comprises processor circuitry 1902 that controls the operation of the second network node 1900. The processor circuitry 1904 is connected to transceiver circuitry 1906 which provides wireless connectivity to other nodes in the system, enabling the second network node to send and receive transmissions carrying control and data signals. For example, the second network node may use the transceiver circuitry 1906 to communicate with a first network node, for example a DU entity. The second network node 1900 may optionally comprise network interface circuitry 1908 for communicating with other nodes in the communications infrastructure, for example core network nodes such as an AMF or other RAN nodes. The memory or memory circuitry 1902 may be connected to the processor circuitry 1904 directly or indirectly and that contains instructions or computer program code executable by the processor circuitry 1904 and other information or data required for the operation of the second network node in accordance with the methods described herein. The second network node may be configured to perform any one of the methods described herein, in relation to a second network node, CU entity or IAB-CU node. In some aspects the processing circuitry 1904 is configured to receive a mobility state information from a first network node, for example a DU entity, for a wireless device which is in a connected mode with a radio access network of which the first network node is a part. For example, the wireless device is in an RRC connected state, having successfully performed an RRC setup or establishment procedure. The processing circuitry 1904 is further configured to perform a mobility management operation and/or a radio resource management operation with the at least one wireless device based on the received mobility state information. This may include signalling via the transceiver circuitry 1906 or the network interface circuitry 1908 or in many examples signalling procedures which involve both the transceiver circuitry 1906 or the network interface circuitry 1908.

An aspect provides a computer program for determining and/or providing a mobility state, the computer program comprising computer code which, when run on processing circuitry of a DU apparatus 1800, or CU apparatus 1900 in a communications system, causes the DU apparatus 1800 or the CU apparatus 1900 to perform methods as described herein pertaining to the DU apparatus 1800 or the CU apparatus 1900 respectively.

A further aspect of the disclosure provides a carrier containing a computer program comprising instructions which, when executed on at least one processor, cause the at least one processor to carry out the method according to any example.

In other aspects of the disclosure the embodiments are performed by a system, for example a system comprising a first network node 1800 and a second network node 1900 in a radio access network configured to communicate with a plurality of wireless devices. The system may comprise logical or physical entities and may be implemented in virtual machines such as a network virtualization environment as previous described in more detail. The system may be configured to perform any one of the embodiments disclosed herein. For example the nodes of the system may be configured to perform the method comprising obtaining 1402 one or more mobility state related parameters, determining 1404, at the first network node, a mobility state information of a wireless device in a connected mode with the radio access network, based on the one or more mobility state related parameters, communicating 1406 the determined mobility state information to the second network node, receiving 1502 the mobility state information at the second network node for the wireless device and performing 1504 one of a mobility management and a radio resource management operation with the at least one wireless device based on the received mobility state information.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It should be noted that the above-mentioned examples illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method performed by a first network node, comprised in a radio access network, the method comprising:
obtaining one or more mobility state related parameters;
determining mobility state information of a wireless device in a connected mode with the radio access network, based on the one or more mobility state related parameters; and
communicating the determined mobility state information to a second network node.

2. The method of claim 1, wherein the mobility state information comprises at least one of:
direction of movement; and
speed information of the wireless device.

3. The method of claim 1, wherein the obtained one or more mobility state related parameters are obtained from at least one of:
an uplink signal received from the wireless device;
information related to downlink reference signals transmitted to the wireless device; and
mobility state information obtained through processing previously stored mobility data of the wireless device.

4. The method of claim 1, wherein the obtained one or more mobility state related parameters comprises one or more of:
a doppler shift in the uplink signals sent by the wireless device;
a timing advanced measured in the uplink signals sent by the wireless device;
a number of beam switches and/or the order of switched beams; and
an angle of arrival of uplink signals sent by the wireless device.

5. The method of claim 1, wherein obtaining the one or more mobility state related parameters comprises the first network node determining at least one mobility state related parameter.

6. The method of claim 1, wherein the obtained one or more mobility state related parameters are based on a rate of change of DL beamforming changes towards the wireless device.

7. The method of claim 6, wherein, the one or more parameters are determined based on:
for analogue beamforming, the rate of change of CSI-RS beams used for data transmission; and
for digital/hybrid beamforming, the rate of change of beamforming vectors and the range of changes in the beamforming vectors.

8. The method of claim 3, wherein the mobility state information obtained by processing previously stored mobility data is obtained from a machine learning entity based on at least one of:
a doppler shift in the UL signals sent by the wireless device;
a timing advanced measured in the uplink signals sent by the wireless device;
a number of beam switches and the order of switched beams;
an angle of arrival of the uplink signals sent by the wireless device;
the wireless device location information;
actual speeds of the wireless device;
wireless device sensor information;
time stamps; and
mobility state information reported by the wireless device.

9. The method of claim 1, wherein the communicated mobility state information comprises one or more of:
a classification of the wireless device mobility state as a relative level of mobility; and
a classification of the direction of the wireless device into one of a predefined set of directions.

10. The method of claim 1, further comprising:
determining the mobility state information periodically; and
communicating the determined mobility state information to the second network node periodically.

11. (canceled)

12. The method of claim 1, further comprising communicating the determined mobility state to the second network node upon satisfying a criterion, wherein the criterion comprises a threshold.

13. (canceled)

14. The method of claim 1, further comprising determining a predicted value of the wireless device speed or a predicted direction of movement and communicating the mobility state information based on the predicted value.

15. The method of claim 1, wherein the communicated mobility state information comprises one or more of the obtained mobility state related parameters.

16. The method of claim 1, further comprising receiving a request for the mobility state information from the second network node, wherein the mobility state information is communicated in a mobility state information reporting message within an F1 application protocol, wherein the first network node is a distributed unit and the second network node is a centralized unit, wherein the first network node is an integrated access and backhaul distributed unit, and wherein the second network node is an integrated access and backhaul centralized unit.

17-19. (canceled)

20. A method performed by a second network node comprised in a radio access network, the method comprising:
receiving a mobility state information from a first network node for at least one wireless device which is in a connected mode with the radio access network; and
performing one of a mobility management and a radio resource management operation with the at least one wireless device based on the received mobility state information.

21. The method of claim 20, wherein performing the mobility management operation comprises performing one of:
a non-conditional handover with the at least one wireless device;
a conditional handover with the at least one wireless device; and
a dual active protocol stack, DAPS, handover.

22. The method of claim 21, wherein the mobility state information comprises at least one of a direction of movement classification and a speed classification and the type of handover is selected based on the at least one direction of movement and speed classification, and wherein the mobility state information comprises a direction of movement classification and the handover is performed to a target cell from a subset of available cells based on the direction of movement classification.

23. (canceled)

24. The method of claim 20, wherein the performing a radio resource management operation comprise the second network node configuring or re-configuring a wireless device based on the received mobility state information, and wherein the second network node:
configures the wireless device with reporting configurations associated to a handover when the reported mobility state information is classified with a first level of mobility;
configures the wireless device with reporting configurations associated to conditional handover when the reported mobility state information is classified with a second level of mobility, wherein the second level of mobility is associated with a greater level of mobility compared to the first level of mobility;
configures fewer measurement objects related to high frequencies compared to the number for lower frequencies; and
configures fewer measurement objects related to frequencies where only small cells are deployed compared to the number of measurement objects for normal or large cells.

25-26. (canceled)

27. The method of claim 20, wherein the second network node is an integrated access and backhaul centralized unit and the first network node is an integrated access and backhaul distributed unit.

28. A first network node, comprising a memory, processing circuitry and transceiver circuitry, the network node configured to:
obtain one or more mobility state related parameters;
determine a mobility state information of a wireless device in a connected mode with a radio access network in which the first network node is comprised, the mobility state information being determined based on the one or more mobility state related parameters; and
communicate the determined mobility state information to a second network node.

29-49. (canceled)
